(19) United States
(12) Patent Application Publication
(10) Pub. No.: US 2022/0046927 A1
(43) Pub. Date: Feb. 17, 2022

(54) DISINFECTANT COMPOSITIONS AND METHODS OF MAKING AND USING THE SAME

(71) Applicants: Tom Johnson, Overland Park, KS (US); Amyn Nanjee, Overland Park, KS (US); Prerna Sonthalia Goradia, Mumbai (IN)

(72) Inventors: Tom Johnson, Overland Park, KS (US); Amyn Nanjee, Overland Park, KS (US); Prerna Sonthalia Goradia, Mumbai (IN)

(21) Appl. No.: 17/402,270

(22) Filed: Aug. 13, 2021

Related U.S. Application Data
(60) Provisional application No. 63/065,285, filed on Aug. 13, 2020.
(60) Provisional application No. 63/065,713, filed on Aug. 14, 2020.

(51) Int. Cl. A01N 59/16; A01N 25/02; C09D 7/65; C09D 1/00; C09D 5/14

(52) U.S. Cl. CPC A01N 59/16; A01N 25/02; C09D 5/14; C09D 1/00; C09D 7/65

(57) ABSTRACT

Disclosed are efficient anti-viral compositions for application to surfaces, or within bulk materials, in order to effectively prevent the spread of the SARS-CoV-2 virus and other viruses or microbes. The disclosed silver-containing composition is particularly effective for its anti-viral properties due to a controlled release of silver ions over time. Some variations provide a disinfectant composition comprising: a silver-containing compound; a polymer; a reducing agent; and optionally, a wetting agent. Certain embodiments provide a disinfectant composition comprising: silver nitrate; a polymer; a reducing agent; optionally, a wetting agent; optionally, a binding agent; and water as solvent. The disinfectant composition may be in solution, gel, spray, foam, dry, or other form, for application to a substrate surface or impregnation into an object. The disinfectant composition may be applied to plastics, glass, wood, metals, metal alloys, ceramics, paper, cardboard, fabrics, textiles, and human skin, for example.

### RELATED APPLICATIONS

This patent application is a non-provisional application claiming priority to U.S. Provisional Patent App. No. 63/065,285, filed on Aug. 13, 2020, and to U.S. Provisional Patent App. No. 63/065,713, filed on Aug. 14, 2020, each of which is hereby incorporated by reference herein.

### FIELD OF THE INVENTION

The present invention generally relates to disinfectant compositions. Particularly, the present invention relates to disinfectant compositions comprising an antimicrobial agent is effective against many virus families including the SARS-CoV-2 virus, as well as and methods of making and using such disinfectant compositions.

### BACKGROUND OF THE INVENTION

Coronavirus disease 2019 (“COVID-19”) is caused by severe acute respiratory syndrome coronavirus 2 (“SARS-CoV-2”). Currently, no effective drug has been proven to treat SARS-CoV-2 infection in humans. The COVID-19 pandemic has led to millions of people being negatively affected globally. Intensive efforts are under way to gain more insight into the mechanisms of viral replication, in order to develop targeted antiviral therapies. However, development of medicines may take years.

The COVID-19 pandemic has emphasized the importance of environmental cleanliness and hygiene management involving a wide variety of surfaces. Despite the strict hygiene measures which have been enforced, it is has proven to be very difficult to sanitize surfaces all of the time. Even when sanitized, surfaces may get contaminated again.

Respiratory secretions or droplets expelled by infected individuals can contaminate surfaces and objects, creating fomites (contaminated surfaces). Viable SARS-CoV-2 virus can be found on contaminated surfaces for periods ranging from hours to many days, depending on the ambient environment (including temperature and humidity) and the type of surface. See, for example, Van Doremalen et al., “Aerosol and surface stability of SARS-CoV-2 as compared with SARS-CoV-1”, New England Journal of Medicine 2020; 382: 1564-1567; Pastorino et al., “Prolonged Infectivity of SARS-CoV-2 in Fomites”, Emerging Infectious Diseases 2020; 26(9); and Chin et al., “Stability of SARS-CoV-2 in different environmental conditions”, The Lancet Microbe, e10, Apr. 2, 2020.

There is consistent evidence of SARS-CoV-2 contamination of surfaces and the survival of the virus on certain surfaces. People who come into contact with potentially infectious surfaces often also have close contact with the infectious person, making the distinction between respiratory droplet and fomite transmission difficult to discern. However, fomite transmission is considered a feasible mode of transmission for SARS-CoV-2, given consistent findings about environmental contamination in the vicinity of infected cases and the fact that other coronaviruses and respiratory viruses can transmit this way (World Health Organization, “Transmission of SARS-CoV-2: implications for infection prevention precautions”, Jul. 9, 2020 via www.who.int). Virus transmission may also occur indirectly through touching surfaces in the immediate environment or objects contaminated with virus from an infected person, followed by touching the mouth, nose, or eyes. While use of face masks has, generally speaking, become widespread, use of hand gloves has not. Even with gloves, touching of mouth, nose, and eyes still frequently occurs, following the touch of a contaminated surface.

Therefore, there is a desire to prevent the transmission of pathogens (such as, but not limited to, SARS-CoV-2) via surfaces. One method of reducing pathogen transmission is to reduce the period of human vulnerability to infection by reducing the period of viability of SARS-CoV-2 on solids and surfaces.

Surfaces may be treated with chemical biocides, such as bleach and quaternary ammoniums salts, or UV light, to disinfect bacteria and destroy viruses within a matter of minutes. Biocides in liquids are capable of inactivating at least 99.99 wt % of SARS-CoV-2 in as little as 2 minutes, which is attributed to the rapid diffusion of the biocide to microbes and because water aids microbial dismemberment. However, these approaches cannot always occur in real-time after a surface is contaminated.

Alternatively, antimicrobial coatings may be applied to a surface in order to kill bacteria and/or destroy viruses as they deposit. However, to exceed 99.9 wt % reduction of bacteria and/or viruses, conventional antimicrobial coatings typically require at least 1 hour, a time scale which is longer than indirect human-to-human interaction time, such as in an aircraft or shared vehicles, for example. Existing solid coatings are limited by a low concentration of biocides at the surface due to slow biocide transport. The slow diffusion of biocides through the solid coating to the surface, competing with the removal of biocides from the surface by human and environmental contact, results in limited availability and requires up to 2 hours to kill 99.9 wt % of bacteria and/or deactivate 99.9 wt % of viruses.

Various alcohol-based disinfectants have been launched which are generally more effective against bacteria compared to viruses. These products are available in solution, gel, or spray form for use on human hand and body surfaces as well as on non-human surfaces such as wood, textiles, metals, polymers, etc. However, the efficacy of alcohol-based disinfectants against viruses has not been established.

Accordingly, what is needed is an efficient anti-viral composition for application to surfaces, or within bulk materials, in order to effectively prevent the spread of the SARS-CoV-2 virus and other viruses.

### SUMMARY OF THE INVENTION

Some variations of the invention provide a disinfectant composition comprising:

(a) a silver-containing compound;

(b) a polymer;

(c) a reducing agent; and

(d) optionally, a wetting agent.

In some embodiments, the silver-containing compound is a silver salt, such as (but not limited to) silver nitrate. In various embodiments, the silver-containing compound is present in a concentration from about 0.01 wt % to about 5 wt %.

The polymer is preferably a hydrophilic polymer. In some embodiments, the polymer is selected from the group consisting of polyacrylamide, poly(acrylamide-co-acrylic acid), poly(vinyl alcohol), poly(vinyl pyrrolidone), poly(ethylene oxide), carboxy methyl cellulose, and combinations thereof. In various embodiments, the polymer is present in a concentration from about 1 wt % to about 5 wt %.

In some embodiments, the reducing agent is selected from the group consisting of citric acid, citrate salt, ascorbic acid, ascorbate salt, ethylenediaminetetraacetic acid, ethylenediaminetetraacetate salt, and combinations thereof. In various embodiments, the reducing agent is present in a concentration from about 1 wt % to about 50 wt %.

In some embodiments, the wetting agent (when present) is selected from the group consisting of polyethoxylated castor oil; polypropylene glycol-polyethylene glycol block copolymers; polyoxyethylene sorbitan monooleate; sodium lauryl sulfate; sodium carboxymethyl cellulose; calcium carboxymethyl cellulose; hydrogenated or non-hydrogenated glycerolipids; ethoxylated or non-ethoxylated, linear or branched, saturated or monounsaturated or polyunsaturated C₆ to C₃₀ fatty acids or salts thereof; cyclodextrin; alkaline earth metal or amine salt ethoxylated or non-ethoxylated esters of sucrose; sorbitol; mannitol; glycerol or polyglycerol containing from 2 to 20 glycerol units; glycols combined with fatty acids, monoglycerides, diglycerides, triglycerides, or mixtures of glycerides of fatty acids; ethoxylated or non-ethoxylated, linear or branched, saturated or monounsaturated or polyunsaturated C₆ to C₃₀ fatty alcohols; sterols; cholesterol or derivatives thereof; ethoxylated or non-ethoxylated ethers of sucrose, sorbitol, mannitol, glycerol, or polyglycerol containing from 2 to 20 glycerol units; hydrogenated or non-hydrogenated, polyethoxylated vegetable oils; polyethylene glycol hydroxystearate; sphingolipids or sphingosine derivatives; polyalkyl glucosides; ceramides; polyethylene glycol-alkyl glycol copolymers; polyethylene glycol-polyalkylene glycol ether di-block or tri-block copolymers; diacetylated monoglycerides; diethylene glycol monostearate; ethylene glycol monostearate; glyceryl monooleate; glyceryl monostearate; propylene glycol monostearate; polyethylene glycol stearate; polyethylene glycol ethers; polyethylene glycol hexadecyl ether; polyethylene glycol monododecyl ether; polyethylene glycol nonyl phenyl ethers; polyethylene glycol octyl phenyl ethers; octylphenoxy polyethoxyethanol; polyhydroxyethyl-tert-octylphenolformaldehyde; poloxamers; polysorbates; sorbitan monolaurate; sorbitan monooleate; sorbitan monopalmitate, sorbitan monostearate; sorbitan sesquioleate; sorbitan trioleate; sorbitan tristearate; phospholipids; and combinations thereof. In various embodiments, the wetting agent is present in a concentration from about 0.1 wt % to about 5 wt %.

The disinfectant composition may further comprise a binding agent. In some embodiments, the binding agent is selected from the group consisting of melamine, thiols, fatty acids, and combinations thereof. In various embodiments, the binding agent (when included) is present in a concentration from about 1 wt % to about 5 wt %.

In certain embodiments, the silver-containing compound is coated with a layer comprising phospholipids bonded with hydrophobic thiols and/or unsaturated fatty acids.

The disinfectant composition may further comprise a copper-containing compound that is present in a concentration from about 0.01 wt % to about 5 wt %, for example.

In various embodiments, the disinfectant composition is in solution, gel, or spray form.

In certain embodiments of the invention, the disinfectant composition is present in a hand-sanitizer formulation.

In typical embodiments, the disinfectant composition is present in a coating on a substrate surface. Alternatively, or additionally, the disinfectant composition may be present as a bulk component within a material or object.

Some variations of the invention provide a disinfectant composition comprising:

(a) silver nitrate;

(b) a polymer;

(c) a reducing agent;

(d) optionally, a wetting agent;

(e) optionally, a binding agent; and

(f) water.

In some embodiments, the silver nitrate is present in a concentration from about 0.01 wt % to about 5 wt %.

In some embodiments, the polymer is poly(vinyl pyrrolidone).

In some embodiments, the reducing agent is citric acid or a salt thereof, such as trisodium citrate. Alternatively, or additionally, the reducing agent may be ethylenediaminetetraacetic acid or a salt thereof.

In some embodiments employing a wetting agent, the wetting agent is polyoxyethylene octyl phenyl ether.

In some embodiments employing a binding agent, the binding agent is melamine.

In some embodiments, the disinfectant composition further comprises silicon dioxide and/or titanium dioxide.

The disinfectant composition may be present in a coating on a substrate surface. The disinfectant composition may be applied to the substrate surface in solution, gel, or spray form, for example.

The disinfectant composition may be present as a bulk component within a material or object, such as personal protective equipment including, but not limited to, protective clothing, gloves, masks, helmets, goggles, pads, guards, and shields.

### DETAILED DESCRIPTION OF EMBODIMENTS OF THE INVENTION

The compositions and methods of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

Reference throughout this specification to “one embodiment,” “some embodiments”, “certain embodiments,” “one or more embodiments,” or “an embodiment” means that a particular feature, structure, material, or characteristic described in connection with the embodiment is included in at least one embodiment of the invention. Thus, the appearances of phrases containing the term “embodiment(s)” in various places throughout this specification are not necessarily referring to the same embodiment of the invention. Furthermore, the particular features, structures, materials, or characteristics may be combined in any suitable manner in one or more embodiments.

As used in this specification and the appended claims, the singular forms “a,” “an,” and “the” include plural referents unless the context clearly indicates otherwise.

Unless defined otherwise, all technical and scientific terms used herein have the same meaning as is commonly understood by one of ordinary skill in the art to which this invention belongs.

In the present disclosure, “%” refers to “wt. %” or “mass %”, unless otherwise stated.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in a Markush group. Thus in some embodiments not otherwise explicitly recited, any instance of “comprising” may be replaced by “consisting of” or, alternatively, by “consisting essentially of.”

Silver (Ag) is a naturally occurring material that has been used for thousands of years for its antimicrobial and antiviral properties. Silver is currently approved for use in numerous medical applications.

Some variations of the present invention are predicated on the discovery of a silver-containing composition that is particularly effective for its anti-viral properties due to a controlled release of silver ions. The present invention provides stable silver particles that do not undergo significant surface oxidation while, at the same time, providing a controlled release of Ag⁺ ions.

It is known that silver salts in solution create silver ions, Ag⁺. The silver ions have anti-viral activity, arising from adhesion or interaction of silver ions to membrane saccharides, lipids, or proteins, causing membrane deformation and inactivation. Normally, the silver ions are quickly consumed or are simply washed away and thus cease to be effective after a short period of time.

The present inventors have discovered that by combining a silver-containing compound (e.g., AgNO₃) with a polymer, a reducing agent, and optionally a wetting agent, the surface electrochemistry of the silver-containing compound may be tuned in order to control the rate and extent of release of Ag⁺ ions. The control of silver-ion release, in the presence of viral or bacterial protein, enables efficient utilization of silver ions—which in turn has beneficial impacts on efficacy, cost, and safety.

In some variations, the disclosed technology coats silver-containing compounds in the form of microparticles having selected sizes and/or shapes to achieve controlled release of Ag⁺ (during use) or no release of Ag⁺ (during storage). This adaptable design allows one to produce a library of membrane-coated silver particles with tuned surface chemistry for a variety of surface-coating applications.

In one example, silver-containing particles with protective organic layers based on electrostatic charges are provided. Antibacterial activity is usually attributed to electrostatic interactions between cations and the negatively charged membrane surface of microbes and/or to other interactions between the cations and a microbe's RNA or DNA proteins. Reactive ion species also may be generated on the surface, to further contribute anti-viral or antimicrobial effectiveness.

Some variations of the invention provide a disinfectant composition comprising:

(a) a silver-containing compound;

(b) a polymer;

(c) a reducing agent; and

(d) optionally, a wetting agent.

As intended herein, “disinfectant” refers to a material capable of causing the inactivation of viruses (such as, but not limited to, SARS-CoV-2 virus), bacteria, yeasts, fungi, molds, or other microbes that may cause human infection.

The silver-containing compound may be any compound of the form AgₙXₘ (n>0, m>0) that is capable of releasing silver cations, usually as Ag⁺ but potentially as Ag²⁺, Ag³⁺, etc., in addition to Ag⁺ or instead of Ag⁺. For convenience in the rest of this specification, reference will be made to monocationic Ag⁺ with the understanding that other silver ions may be released. The species X may be a single atom such as chlorine (Cl) or may itself contain multiple atomic species, such as a nitrate group (NO₃). The silver-containing compound is typically a neutral molecule but may be positively or negatively charged.

In some embodiments, the silver-containing compound is a silver salt. Exemplary silver salts include silver halides such as silver chloride (AgCl), silver fluoride (AgF, AgF₂, AgF₃, and/or Ag₂F), silver bromide (AgBr), silver iodide (AgI), or a combination thereof. Other exemplary silver salts include silver nitrate (AgNO₃), silver acetate (AgCH₃COO), silver carbonate (Ag₂CO₃), silver citrate (Ag₃C₆H₅O₇), silver lactate (AgC₃H₅O₃), silver phosphate (Ag₃PO₄), silver sulfate (Ag₂SO₄), silver perchlorate (AgClO₄), silver trifluoroacetate (AgCF₃COO), silver sulfadiazine (AgC₁₀H₉N₄O₂S), and combinations thereof, for example. In some preferred embodiments, the silver salt is silver nitrate. Exemplary silver-containing compounds that are not ordinarily classified as salts include, but are not limited to, silver sulfide (Ag₂S), silver oxide (Ag₂O), silver nitride (Ag₃N), silver hydride (AgH), and silver carbide (Ag₂C₂, usually referred to as silver acetylide).

In various embodiments, the silver-containing compound is present in a concentration from about 0.01 wt % to about 5 wt %. The silver-containing compound may be present in a concentration of about, at least about, or at most about 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.1 wt %, 1.2 wt %, 1.3 wt %, 1.4 wt %, 1.5 wt %, 1.6 wt %, 1.7 wt %, 1.8 wt %, 1.9 wt %, 2 wt %, 2.1 wt %, 2.2 wt %, 2.3 wt %, 2.4 wt %, 2.5 wt %, 3 wt %, 3.5 wt %, 4 wt %, 4.5 wt %, or 5 wt %, including all intervening ranges.

In this specification, reference to “intervening ranges” is in reference to embodiments in which there is a sub-selection of numbers within a larger range of numbers. For instance, the silver-containing compound concentration may specifically be sub-selected within a range of 0.02-2.5 wt %, 1-3 wt %, or any other range that starts and ends with two of the recited concentrations.

The particle size of the silver-containing compound may vary. In some embodiments, the average particle size of the silver-containing compound is selected from about 0.1 microns to about 10 microns. In various embodiments, the average particle size of the silver-containing compound is about, at least about, or at most about 0.2, 0.3, 0.4, 0.5, 0.6, 0.7, 0.8, 0.9, 1, 1.5, 2, 2.5, 3, 4, 5, 6, 7, 8, 9, or 10 microns, including all intervening ranges. In certain embodiments, the average particle size of the silver-containing compound is at least about 0.5 microns (500 nanometers). Note that it is possible to utilize silver-containing compound particles having an average particle size less than 0.1 microns, such as about 90, 80, 70, 60, 50, 40, 30, 20, or 10 nanometers or even smaller (i.e., nanoparticles). Typically, however, the average particle size of the silver-containing compound is greater than 0.1 micron (100 nanometers). Also it is possible to utilize silver-containing compound particles having an average particle size larger than 10 microns, such as about 20, 30, 40, 50, 60, 70, 80, 90, or 100 microns or even larger.

When the silver-containing compound is chemically or physically bound to other components (such as a polymer or a reducing agent) to form a complexed particle, the measured particle size will typically be that of the complexed particle.

Particle sizes may be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

The particle shape of the silver-containing compound may vary. For example, the particle shape may be selected from spheres, ovoids, cubes, pyramids, plates, rods, needles, random shapes, or a combination thereof. The silver-containing compound may be characterized by an average aspect ratio of the maximum length scale to the minimum length scale. The average aspect ratio may vary from 1 (e.g., spheres or cubes) to 100 or greater (e.g., needle-like particles). In some embodiments, substantially a single particle shape characterizes the silver-containing compound. In other embodiments, a combination of multiple particle shapes characterizes the silver-containing compound within the composition. Particle shape may be determined using image analysis with photomicrographs, scanning electron micrographs, or other images.

The polymer is preferably a hydrophilic polymer. In some embodiments, the polymer is selected from the group consisting of polyacrylamide, poly(acrylamide-co-acrylic acid), poly(vinyl alcohol), poly(vinyl pyrrolidone), poly(ethylene oxide), carboxy methylcellulose, and combinations thereof.

In certain embodiments, poly(vinyl pyrrolidone) is utilized as the polymer. A commercially available poly(vinyl pyrrolidone) is PVP K-30 which is a hygroscopic, amorphous polymer that can be plasticized with water and most common plasticizers. It has high polarity and propensity to form bonds with hydrogen donors such as phenols, carboxylic acids, anionic dyes, and inorganic salts.

The polymer may be present in a concentration from about 0.1 wt % to about 75 wt % within the disinfectant composition. In some embodiments, the polymer is present in a concentration from about 1 wt % to about 10 wt %, or from about 1 wt % to about 5 wt %. In various embodiments, the polymer is present in a concentration of about, at least about, or at most about 0.1 wt %, 0.2 wt %, 0.3 wt %, 0.4 wt %, 0.5 wt %, 1 wt %, 1.5 wt %, 2 wt %, 3 wt %, 4 wt %, 5 wt %, 6 wt %, 7 wt %, 8 wt %, 9 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, or 75 wt %, including all intervening ranges.

In the disinfectant composition, the weight ratio of silver-containing compound to polymer may vary, such as from about 0.0001 to about 10, for example. In various embodiments, the weight ratio of silver-containing compound to polymer is about, at least about, or at most about 0.0001, 0.001, 0.005, 0.01, 0.05, 0.1, 0.5, 1, 2, 5, or 10, including all intervening ranges.

The reducing agent is a chemical that is capable of reducing a cation to cause an acceptance of one or more electrons (donated by the reducing agent), decreasing the cation charge to a less-positive charge, to a neutral molecule, or to a negatively charged anion. The reducing agent may also be referred to as a complexing agent.

In some embodiments, the reducing agent is selected from the group consisting of citric acid, citrate salt, ascorbic acid, ascorbate salt, ethylenediaminetetraacetic acid (EDTA), ethylenediaminetetraacetate salt, and combinations thereof. Exemplary citrate salts include sodium citrate (also referred to as trisodium citrate), potassium citrate, potassium-sodium citrate, and potassium-magnesium citrate, for example. Exemplary ascorbate salts include sodium ascorbate, calcium ascorbate, and potassium ascorbate, for example. Exemplary ethylenediaminetetraacetate salts include disodium ethylenediaminetetraacetate, dipotassium ethylenediaminetetraacetate, sodium calcium ethylenediaminetetraacetate, tetrasodium ethylenediaminetetraacetate, or a combination thereof. Generally, EDTA salts may include ammonium, calcium, copper, iron, potassium, manganese, sodium, or zinc salts of EDTA. Other organic acids, organic-acid salts, aminopolycarboxylic acids, or aminopolycarboxylate salts may be employed as reducing agents.

For example, a reducing agent may be an organic compound selected from the group consisting of formic acid, glyoxilic acid, oxalic acid, acetic acid, glocolic acid, acrylic acid, pyruvic acid, malonic acid, propanoic acid, hydroxypropanoic acid, lactic acid, glyceric acid, fumaric acid, maleic acid, oxaloacetic acid, crotonoic acid, acetoacetic acid, 2-oxobutanoic acid, methylmalonic acid, succinic acid, methylsuccinic acid, malic acid, tartaric acid, dihydroxytartaric acid, butanoic acid, hydroxybutanoic acid, itaconic acid, mesaconic acid, oxoglutaric acid, glutaric acid, valeric acid, pivalic acid, aconitic acid, ascorbic acid, citric acid, isocitric acid, adipic acid, caproic acid, benzoic acid, salicylic acid, gentisic acid, protocatechuic acid, gallic acid, cyclohexanecarboxylic acid, pimelic acid, phthalic acid, terephthalic acid, phenylacetic acid, toluic acid, mandelic acid, suberic acid, octanoic acid, cinnamic acid, nonanoic acid, salts thereof, and combinations of the foregoing.

The reducing agent may be present in a concentration from about 0.1 wt % to about 50 wt %, for example. In various embodiments, the concentration of the reducing is about, at least about, or at most about 0.1 wt %, 0.2 wt %, 0.3 wt %, 0.4 wt %, 0.5 wt %, 1 wt %, 1.5 wt %, 2 wt %, 3 wt %, 4 wt %, 5 wt %, 6 wt %, 7 wt %, 8 wt %, 9 wt %, 10 wt %, 15 wt %, 20 wt %, 25 wt %, 30 wt %, 35 wt %, 40 wt %, 45 wt %, or 50 wt %, including all intervening ranges.

In the disinfectant composition, the weight ratio of silver-containing compound to reducing agent may vary, such as from about 0.01 to about 10, for example. In various embodiments, the weight ratio of silver-containing compound to reducing agent is about, at least about, or at most about 0.01, 0.05, 0.1, 0.5, 1, 2, 5, or 10, including all intervening ranges.

The disinfectant composition may further comprise a wetting agent. The wetting agent may function as a surfactant at interfaces between different components of the disinfectant composition. Alternatively, or additionally, the wetting agent may function as a surfactant at an interface between the disinfectant composition and a substrate surface to which the disinfectant composition is to be applied. Surfactants may be anionic, cationic, zwitterionic, or non-ionic surfactants.

In some embodiments, the wetting agent (when present) is selected from the group consisting of polyethoxylated castor oil; polypropylene glycol-polyethylene glycol block copolymers; polyoxyethylene sorbitan monooleate; sodium lauryl sulfate; sodium carboxymethyl cellulose; calcium carboxymethyl cellulose; hydrogenated or non-hydrogenated glycerolipids; ethoxylated or non-ethoxylated, linear or branched, saturated or monounsaturated or polyunsaturated C₆ to C₃₀ fatty acids or salts thereof; cyclodextrin; alkaline earth metal or amine salt ethoxylated or non-ethoxylated esters of sucrose; sorbitol; mannitol; glycerol or polyglycerol containing from 2 to 20 glycerol units; glycols combined with fatty acids, monoglycerides, diglycerides, triglycerides, or mixtures of glycerides of fatty acids; ethoxylated or non-ethoxylated, linear or branched, saturated or monounsaturated or polyunsaturated C₆ to C₃₀ fatty alcohols; sterols; cholesterol or derivatives thereof; ethoxylated or non-ethoxylated ethers of sucrose, sorbitol, mannitol, glycerol, or polyglycerol containing from 2 to 20 glycerol units; hydrogenated or non-hydrogenated, polyethoxylated vegetable oils; polyethylene glycol hydroxystearate; sphingolipids or sphingosine derivatives; polyalkyl glucosides; ceramides; polyethylene glycol-alkyl glycol copolymers; polyethylene glycol-polyalkylene glycol ether di-block or tri-block copolymers; diacetylated monoglycerides; diethylene glycol monostearate; ethylene glycol monostearate; glyceryl monooleate; glyceryl monostearate; propylene glycol monostearate; polyethylene glycol stearate; polyethylene glycol ethers; polyethylene glycol hexadecyl ether; polyethylene glycol monododecyl ether; polyethylene glycol nonyl phenyl ethers; polyethylene glycol octyl phenyl ethers; octylphenoxy polyethoxyethanol; polyhydroxyethyl-tert-octylphenolformaldehyde; poloxamers; polysorbates; sorbitan monolaurate; sorbitan monooleate; sorbitan monopalmitate, sorbitan monostearate; sorbitan sesquioleate; sorbitan trioleate; sorbitan tristearate; phospholipids; and combinations thereof.

In certain embodiments, the wetting agent is a surfactant selected from Kolliphor EL, Poloxamer 407, Tween 80, or Triton X-100. In certain embodiments, the wetting agent is selected from the group consisting of macrogol stearate 400, macrogol stearate 2000, polyoxyethylene 50 stearate, macrogol ethers, cetomacrogol 1000, lauramacrogols, nonoxinols, octoxinols, tyloxapol, poloxamers, polysorbate 20, polysorbate 40, polysorbate 60, polysorbate 65, polysorbate 80, polysorbate 85, and combinations thereof.

The wetting agent may be present in a concentration from about 0.01 wt % to about 5 wt %, for example. In various embodiments, the wetting agent is in a concentration of about, at least about, or at most about 0 wt %, 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %, including all intervening ranges.

In some embodiments, the disinfectant composition includes a phospholipid as a wetting agent and/or as a component of a coating layer disposed on the silver-containing compound. In certain embodiments, for example, the silver-containing compound is coated with a layer comprising phospholipids bonded with hydrophobic thiols and/or bonded with unsaturated fatty acids.

The disinfectant composition may further comprise a binding agent. In some embodiments, the binding agent is selected from the group consisting of melamine, thiols, fatty acids, adhesives, polymers, acrylates, and combinations thereof. The binding agent may also be referred to as a surface binder.

The binding agent (when included) may be present in a concentration from about 0.01 wt % to about 5 wt %, for example. In various embodiments, the binding agent is in a concentration of about, at least about, or at most about 0 wt %, 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %, including all intervening ranges.

In some embodiments, the disinfectant composition comprises:

(a) silver nitrate;

(b) at least one polymer;

(c) at least one reducing agent;

(d) at least one wetting agent; and

(e) at least one surface binder.

In certain embodiments, the disinfectant composition comprises:

(a) silver nitrate;

(b) polyvinyl pyrrolidone;

(c) trisodium citrate;

(d) polyoxyethylene octyl phenyl ether; and

(e) melamine.

In these embodiments, the silver nitrate is a silver-containing compound, the polyvinyl pyrrolidone is a polymer, the trisodium citrate is a reducing agent, the polyoxyethylene octyl phenyl ether is a wetting agent, and the melamine is a surface binder.

The disinfectant composition may further comprise a copper-containing compound. Copper, like silver, has known antiviral properties. For example, it has been shown that copper ions, like silver ions, have specific affinity for double-stranded DNA. See, for example, Lu et al., “Silver nanoparticles inhibit hepatitis B virus replication”, Antiviral Therapy 2008, 13, 253-62 and Borkow et al., “Copper as a biocidal tool”, Current Medicinal Chemistry, 2005, 12, 2163-75, which are hereby incorporated by reference herein.

The copper-containing compound (when present) may be any compound of the form CuₚY_{q} (p>0, q>0) that is capable of releasing copper cations, usually as Cu²⁺ but potentially as Cu⁺, Cu³⁺, etc., in addition to Cu²⁺ or instead of Cu²⁺. The species Y may be a single atom such as chlorine (Cl) or may itself contain multiple atomic species, such as a nitrate group (NO₃). In this disclosure, Y does not refer to the element yttrium. The copper-containing compound is typically a neutral molecule but may be positively or negatively charged.

In some embodiments, the copper-containing compound is a copper salt. Exemplary copper salts include copper halides such as copper chloride (CuCl and/or CuCl₂), copper fluoride (CuF and/or CuF₂), copper bromide (CuBr and/or CuBr₂), copper iodide (CuI), or a combination thereof. Other exemplary copper salts include copper nitrate (Cu(NO₃)₂), copper acetate (Ag(CH₃COO)₂), copper carbonate (CuCO₃), and copper sulfate (CuSO₄), for example. In some preferred embodiments, the copper salt is copper nitrate. Exemplary copper-containing compounds that are not ordinarily classified as salts include, but are not limited to, copper sulfide (e.g., CuS), copper oxide (CuO and/or Cu₂O), copper nitride (Cu₃N₂), copper hydride (CuH), and copper carbide (Cu₂C₂, usually referred to as copper acetylide).

The copper-containing compound may be present in a concentration from about 0.01 wt % to about 5 wt %, for example. In various embodiments, the copper-containing compound is present in a concentration of about, at least about, or at most about 0 wt %, 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %, including all intervening ranges.

When both silver-containing compounds and copper-containing compounds are employed in a disinfectant composition, such compounds and their concentrations may be independently selected from the above lists, for example. In some embodiments employing both silver-containing compounds and copper-containing compounds, the counterions or bonded species X and Y, within AgₙXₘ and CuₚY_{q}, respectively, may be the same (X=Y), or they may be different (X≠Y). For example, a combination of silver nitrate and copper nitrate may be employed (X=Y), or a combination of silver chloride and copper nitride may be employed (X≠Y). The silver-containing compound and the copper-containing compound are not typically chemically bound to each other, although some degree of association may occur. Ion-exchange reactions between the silver-containing compound and the copper-containing compound may take place such that counterions or bonded species X and Y, within AgₙXₘ and CuₚY_{q}, respectively, may switch.

In embodiments employing both a silver-containing compound and a copper-containing compound, the silver-containing compound and the copper-containing compound may independently each be present in a concentration from about 0.005 wt % to about 5 wt %, for example, such as about, at least about, or at most about 0.005 wt %, 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, or 5 wt %, including all intervening ranges.

In embodiments employing both a silver-containing compound and a copper-containing compound, the sum of the concentrations of the silver-containing compound and the copper-containing compound may be about, at least about, or at most about 0.01 wt %, 0.02 wt %, 0.03 wt %, 0.04 wt %, 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, or 10 wt %, including all intervening ranges, for example.

In embodiments employing both a silver-containing compound and a copper-containing compound, the mass ratio of silver-containing compound to copper-containing compound may vary from about 0.01 to about 100, for example. In various embodiments employing such combination, the mass ratio of silver-containing compound to copper-containing compound may be about, at least about, or at most about 0.01, 0.1, 0.5, 1, 2, 3, 4, 5, 10, 20, 30, 40, 50, 60, 70, 80, 90, or 100, including all intervening ranges, for example.

The particle size of the copper-containing compound (when present) may vary. In some embodiments, the average particle size of the copper-containing compound is selected from about 0.1 microns to about 10 microns. In various embodiments, the average particle size of the copper-containing compound is about, at least about, or at most about 0.2, 0.3, 0.4, 0.5, 0.6, 0.7, 0.8, 0.9, 1, 1.5, 2, 2.5, 3, 4, 5, 6, 7, 8, 9, or 10 microns, including all intervening ranges. In certain embodiments, the average particle size of the copper-containing compound is at least about 0.5 microns (500 nanometers). Typically, the average particle size of the copper-containing compound is greater than 0.1 micron (100 nanometers). Also it is possible to utilize copper-containing compound particles having an average particle size larger than 10 microns, such as about 20, 30, 40, 50, 60, 70, 80, 90, or 100 microns or even larger.

When the copper-containing compound is chemically or physically bound to other components (such as a polymer, a reducing agent, or the silver-containing compound) to form a complexed particle, the measured particle size will typically be that of the complexed particle.

In embodiments employing both a silver-containing compound and a copper-containing compound, the average particle size of the silver-containing compound and the average particle size of the copper-containing compound may be the same or different.

The particle shape of the copper-containing compound (when present) may vary. For example, the particle shape may be selected from spheres, ovoids, cubes, pyramids, plates, rods, needles, random shapes, or a combination thereof. The copper-containing compound may be characterized by an average aspect ratio of the maximum length scale to the minimum length scale. The average aspect ratio may vary from 1 (e.g., spheres or cubes) to 100 or greater (e.g., needle-like particles). In some embodiments, substantially a single particle shape characterizes the copper-containing compound. In other embodiments, a combination of multiple particle shapes characterizes the copper-containing compound within the composition. Particle shape may be determined using image analysis with photomicrographs, scanning electron micrographs, or other images.

In embodiments employing both a silver-containing compound and a copper-containing compound, the particle shape(s) of the silver-containing compound and the particle shape(s) of the copper-containing compound may be the same or different.

The disinfectant composition preferably comprises a liquid solvent. The liquid solvent dissolves at least some of the composition components, and preferably dissolves all of the composition components, at least to some extent (and preferably, substantially completely). A typical solvent is water. Other polar solvents may be employed. Polar solvents may be protic polar solvents or aprotic polar solvents. Exemplary polar solvents include, but are not limited to, water, alcohols, ethers, esters, ketones, aldehydes, carbonates, and combinations thereof.

The choice of solvent will generally be dictated primarily by the selection of silver-containing compound (and copper-containing compound if present). The solvent may also be chosen based, to some extent, on the selection of the polymer, the reducing agent, the wetting agent (if present), and the binding agent (if present). For example, when the silver-containing compound is silver nitrate, water is an effective solvent because silver nitrate is highly soluble in water. An additive may be used to increase the water solubility of the silver-containing compound. For example, silver chloride has very low solubility in water but when cetrimonium chloride is used, water can be a suitable solvent or co-solvent.

The concentration of solvent may vary. The solvent concentration may be the minimum concentration that dissolves the silver-containing compound, or may be present in excess (which is typical). For example, the solvent concentration may be selected from about 10 wt % to about 99 wt %, such as about, at least about, or at most about 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, or 99 wt %, including all intervening ranges.

The solvent is normally a distinct chemical species from the primary components of the disinfectant composition. In certain embodiments, the reducing agent and/or the wetting agent themselves function as solvents for the silver-containing compound and the other components dissolved.

While the disinfectant composition is preferably prepared with a solvent, it is noted that a dried form of the disinfectant composition may be prepared, such as in powder form. Spray drying may be used for making a powder form of the disinfectant composition. A disinfectant composition may be completely dry (i.e., no water present) or may contain some water but less water than necessary for equilibrium dissolution of all components, or less water than necessary for equilibrium dissolution of the silver-containing compound. The dry disinfectant composition may be packaged, stored, sold, etc. and a solvent (e.g., water) then added at a later time, such as prior to or during use.

The electric potential (redox potential) of the disinfectant composition is preferably maintained in the reductive regime so that the silver remains substantially in its zero-valent state (as)Ag⁰, while also slowing releasing Ag⁺ ions. The type and concentration of reducing agent may be selected in order to maintain a reductive regime for the disinfectant composition.

Also, the pH of the disinfectant composition is preferably selected from about 5 to about 9, more preferably from about 6 to about 8, and most preferably from about 6.5 to about 7.5 (e.g., about 7). Some embodiments provide a slightly basic disinfectant composition, with a pH from about 7 to about 8. Optionally, a weak base is added to the disinfectant composition in order to maintain slight basicity. In various embodiments, the pH of the disinfectant composition is about, at least about, or at most about 5, 5.5, 6.0, 6.1, 6.2, 6.3, 6.4, 6.5, 6.6, 6.7, 6.8, 6.9, 6.95, 7.0, 7.05, 7.1, 7.2, 7.3, 7.4, 7.5, 7.6, 7.7, 7.8, 7.9, 8.0, 8.5, or 9.0, including all intervening ranges. A pH buffer may be included in the disinfectant composition to help stabilize its pH.

The electric potential and the pH of the disinfectant composition are preferably selected such that molecules in solution associate with the surface of the silver-containing compound to establish multiple layers of charges. These layers of charges stabilize the silver-containing compound particles and inhibit decomposition as well as aggregation. Inhibiting decomposition is preferred so that Ag⁺ ions are not released too quickly. Inhibiting aggregation is preferred to avoid mass-transfer limitations of Ag⁺ ions from the silver-containing compound, through the polymer and reducing agent, and ultimately to the viral protein of interest for deactivation. Preferably, the concentration of Ag⁺ ions that arises from the ion release is sufficient to quickly , or even instantly, deactivate a virus or other microbe.

A balance is important between Ag⁺ ion slow generation, on the one hand, and silver-containing compound decomposition, on the other hand. A controlled release of silver ions is achieved according to the principles of the invention. For example, by selecting the type and concentration of the polymer and the reducing agent, as well as optimizing the pH and electric potential of the composition, the polymer decomposes slowly over time. In conjunction with this polymer decomposition, silver ions are released. The rate of release may vary such that the conversion of Ag⁰ to Ag⁺ ions occurs over a period of at least 30 days, preferably at least 60 days, and more preferably at least 90 days, measured at 25° C. In some embodiments, the conversion (at 25° C.) of Ag⁰ to Ag⁺ ions occurs in a time period from about 30 days to about 180 days, such as from about 60 days to about 120 days, e.g. about 90 days. Another measure of the rate of release is the extent of conversion of Ag⁰ to Ag⁺ ions occurring in 90 days at 25° C. Such extent of conversion may be from about 50% to 100%, such as about, or at least about, 50%, 60%, 70%, 80%, 90%, 95%, 99%, 99.9%, or 100%.

It will be appreciated that the rate and extent of conversion of Ag⁰ to Ag⁺ ions, for a silver-containing compound, is not solely an intrinsic property of the disinfectant composition. The rate and extent of conversion to ions also depends extrinsically on the environmental conditions (e.g., temperature, pH, and humidity) and specific compounds encountered which may cause chemical reactions to take place. In certain embodiments, silver-containing particles are suspended in an aqueous citrate buffer (combination of citric acid and sodium citrate), which weakly associates with the silver-containing particle surface. This citrate-based buffer forms a weakly bound capping agent that provides long-term stability when the composition is being stored or even when it is in use but prior to exposure to viral protein. Later, the citrate-based buffer is readily displaced by various other molecules including proteins, antibodies, thiols, or amines, triggering a release mechanism involving the conversion of Ag⁰ to Ag⁺ ions. Other wetting agents (besides citrate buffers) may be utilized in these embodiments.

Generally speaking, the present invention is not limited by any particular hypothesis or mechanism of action of silver ions (or copper ions) in inactivating viruses (e.g., SARS-CoV-2 virus), bacteria, fungi, or yeasts. For example, silver ions may cause to lipid peroxidation of a viral or bacterial membrane via formation of reactive species, causing cellular lysis. Adhesion or interaction of silver ions to membrane saccharides, lipids, or proteins may cause membrane deformation, leading to loss of membrane potential and inactivation. Direct biocidal effects of silver ions may occur through interactions with DNA or critical cellular proteins. Silver is a photosensitizer which generates singlet oxygen when exposed to light. The singlet oxygen oxidizes the viral or bacterial protein and/or lipid, consequently leading to the inactivation of microbes. Combinations of multiple mechanisms are possible.

The disinfectant composition may contain various additives, in addition to the primary and optional components described above. A wide variety of additives may be incorporated, such as (but not limited to) diluents, carriers, vehicles, excipients, fillers, viscosity-modifying agents (e.g., thickeners or thinners), UV stabilizers, thermal stabilizers, antioxidants, pH buffers, acids, bases, metals (e.g., neutral silver or neutral copper particles), humectants, sequestering agents, texturing agents, or colorants. Exemplary additives include, but are not limited to, silicon dioxide (silica, SiO₂), titanium dioxide (titania, TiO₂), talc, silicates, aluminosilicates, butylated hydroxytoluene (BHT), sodium bicarbonate, and calcium carbonate, barium sulfate, mica, diatomite, wollastonite, calcium sulfate, zinc oxide, and carbon. Some additives, such as TiO₂ and SiO₂, may serve multiple functions.

The disinfectant composition is preferably stable to light (primarily UV light) and heat. If necessary, one or more additives (such as TiO₂) may be included specifically to confer UV resistance to the disinfectant composition. Other UV stabilizers include thiols, hindered amines (e.g., a derivative of tetramethylpiperidine), UV-absorbing particles (e.g., CdS, CdTe, or ZnS), or a combination thereof, for example.

When additives are included in the disinfectant composition, the particle size of the additives may vary. In some embodiments, the average particle size of an additive is selected from about 0.5 microns to about 100 microns. In various embodiments, the average particle size of an additive is about, at least about, or at most about 0.5, 0.6, 0.7, 0.8, 0.9, 1, 1.5, 2, 2.5, 3, 4, 5, 6, 7, 8, 9, 10, 15, 20, 25, 30, 40, 50, 60, 70, 80, 90, or 100 microns, including all intervening ranges. In certain embodiments, the average particle size of any additive is at least about 0.5 microns. Typically, the average particle size of any additive is greater than 0.1 micron, but nanoparticle additives with sizes less than 0.1 micron (100 nanometers) may optionally be employed.

Some variations of the invention provide a disinfectant composition comprising:

(a) silver nitrate;

(b) a polymer;

(c) a reducing agent;

(d) optionally, a wetting agent;

(e) optionally, a binding agent; and

(f) water.

In some disinfectant compositions, the silver nitrate is present in a concentration from about 0.01 wt % to about 5 wt %.

In some disinfectant compositions, the polymer is poly(vinyl pyrrolidone).

In some disinfectant compositions, the reducing agent is citric acid or a salt thereof, such as trisodium citrate. Alternatively, or additionally, the reducing agent may be ethylenediaminetetraacetic acid or a salt thereof.

In some disinfectant compositions employing a wetting agent, the wetting agent is polyoxyethylene octyl phenyl ether.

In some disinfectant compositions employing a binding agent, the binding agent is melamine.

In some disinfectant compositions, the composition further comprises silicon dioxide, titanium dioxide, or both silicon dioxide and titanium dioxide.

The disinfectant composition may be present in a coating on a substrate surface. The disinfectant composition may be applied to the substrate surface in solution, gel, or spray form, for example.

The disinfectant composition may be present as a bulk component within a material or object, such as personal protective equipment including, but not limited to, protective clothing, gloves, masks, helmets, goggles, pads, guards, and shields.

Various methods of preparing disinfectant compositions may be employed, as will now be further described. The starting components (silver-containing compound, polymer, reducing agent, and any optional components) may be obtained from commercial sources or may be synthesized from precursors in a laboratory or industrial plant.

The starting components are typically obtained or synthesized and then combined by mixing. Mixing may be accomplished using known apparatus, such as (but by no means limited to) paddle mixers, ribbon blenders, tumbling mixers, dispersers, high-shear mixers, multi-shaft mixers, planetary mixers, vertical blenders, static mixers, or homogenizers.

Mixing may be continuous, semi-continuous, or in batch. Known statistical principles may be used to determine an effective mixing time in order to achieve a homogeneous disinfectant composition. In certain embodiments, mixing relies only on diffusion after combining the starting components, without agitation, which will take longer to achieve a homogeneous solution.

A solvent may be added prior to, or during, mixing. The solution obtained by mixing may be further processed, such as via filtration, centrifugation, evaporation, or drying, for example. Filtration may be conducted to separate particles by particle size, for example. Centrifugation may be conducted to separate particles by particle size or to separate excess liquid from a previous step, for example. Evaporation or drying may be conducted to prepare a dry form of the disinfectant composition, either for direct use as a dry composition or for later adding a solvent.

In some methods to prepare a disinfectant composition, silver-containing particles are capped with a hydrophilic polymer such as polyacrylamide, poly(acrylamide-co-acrylic acid), poly(vinyl alcohol), or poly(vinyl pyrrolidone) which have a tendency to hydrogen bond in aqueous solutions. Other possible capping agents are carboxy methylcellulose and polyethylene oxide which are also water-soluble. The polymer concentration may be at a concentration of about 2 wt % based on the final composition. A reducing agent such as ascorbic acid or sodium citrate is then added to the mixture, at a concentration of about 10 wt % to 25 wt % based on the final composition. Optionally, the composition incorporates a melamine, which is a trimer of cyanamide. Melamine is a surface binder that provides beneficial binding ability of the composition to a textile fabric (substrate surface). The combination of the hydrophilic polymer and the surface binder gives a unique binding ability of the composition—in particular, the silver-containing particles—to the surface.

In some methods to prepare a disinfectant composition, synthesis of silver-containing particles with robust hybrid lipid-coated layers is performed. The layers may comprise natural-source phospholipids such as L-α-phosphatidylcholine bound by long-chained hydrophobic thiols and/or monounsaturated fatty acids as hydrophobic binding agents. This configuration inhibits the Ag from undergoing surface oxidation and Ag⁺ ion dissolution, while at the same time, Ag⁺ ions are slowly released from the coating after the substrate surface has been coated, or from the bulk material after it has been infiltrated with the disinfectant composition.

In some methods to prepare a disinfectant composition, the particle size of the silver-containing compound is controlled. Selection of particle size may be accomplished by controlling the chemical synthesis of the silver-containing compound (e.g., the synthesis of silver nitrate from silver metal and nitric acid). Selection of particle size may also be accomplished by separating particles by particle size, such as via filtration. For example, in some embodiments, the particle size is controlled such that the average particle size of the silver-containing compound is greater than 30 nanometers, greater than 100 nanometers, or greater than 500 nanometers. In certain embodiments, the particle size is controlled such that the average particle size of the silver-containing compound, or the range of particle sizes present, is selected from about 0.5 microns to about 10 microns, for example.

In some methods to prepare a disinfectant composition, the disinfectant composition is produced in solution form. In some methods to prepare a disinfectant composition, the disinfectant composition is produced in gel form. In some methods to prepare a disinfectant composition, the disinfectant composition is produced in spray form. Different additives may be incorporated during synthesis, depending on the final form. For example, when a gel form is desired, a viscosity-adjusting additive may be employed (e.g., carbomers, cellulose derivatives, or other gelling agents). When a spray form is desired, a propellant may be employed (e.g., carbon dioxide or nitrous oxide).

Various methods of using disinfectant compositions may be employed, as will now be further described.

In some methods of using a disinfectant composition, the disinfectant composition—in solution, gel, spray, foam, dry, or other form—is applied to a substrate surface. The substrate surface may vary widely, such as (but not limited to) plastics, glass, wood, metals (e.g., aluminum), metal alloys (e.g., stainless steel), ceramics, paper, cardboard, fabrics/textiles, and human skin. The substrate surface may be a household surface, an industrial surface, or another type of surface. The substrate surface may be a porous or non-porous surface.

Generally, when the disinfectant composition forms a coating on an object, the coating deposition may be integrated into the overall fabrication of the object, or the object may be fabricated and then, at a later time, the coating deposited.

The step of application of the disinfectant composition to the substrate surface may include spraying, coating, casting, pouring, or other techniques. In some embodiments, a disinfectant composition is prepared and then dispensed (deposited) over an area of interest. Any known methods to deposit disinfectant compositions may be employed. Various coating techniques include, but are not limited to, spray coating, dip coating, doctor-blade coating, spin coating, air knife coating, curtain coating, single and multilayer slide coating, gap coating, knife-over-roll coating, metering rod (Meyer bar) coating, reverse roll coating, rotary screen coating, extrusion coating, casting, or printing. The disinfectant composition may be rapidly sprayed or cast in thin layers over large areas.

In certain embodiments of the invention, the disinfectant composition is incorporated as, or into, a hand-sanitizer formulation. The United States Centers for Disease Control and Prevention and many other world public health authorities recommend hand sanitizers as an acceptable alternative to soap and water for hand hygiene. A hand-sanitizer formulation contains a disclosed disinfectant composition and generally may further contain one or more thickening agents and other additives, such as glycerol, polyacrylic acid, acrylates/C₁₀-C₃₀ alkyl acrylate crosspolymer, isopropyl myristate, propylene glycol, caprylyl glycol, phenoxyethanol, benzophenone-4, tocopheryl acetate, essential oils of plants, fragrances, or a combination thereof, for example.

In some methods of using a disinfectant composition, the disinfectant composition—in solution, dry, or other form—is incorporated as a bulk component within a material or object. In these embodiments, the disinfectant composition is not solely at a surface but is also within the bulk region of the particular material or object. The material or object for bulk incorporation of the disinfectant composition may vary widely, such as (but not limited to) polymeric objects (e.g., PPE gloves), composites (e.g., polymer composites or ceramic matrix composites), metallic objects (e.g., metallic doorknobs or handles), ceramic objects (e.g., ceramic tiles), fabrics (e.g., carpets), or textiles (e.g., clothing), for example.

When a dry form of a disinfectant composition is added to a surface or incorporated within a bulk object, the disinfectant composition may be introduced during fabrication of the bulk object at an appropriate step(s). The dry form of the disinfectant composition may be solubilized, at least partially, during fabrication. This solubilization may occur by addition of a solvent (e.g., water) at some point during fabrication. Alternatively, or additionally, the solubilization may take advantage of a liquid that is already (normally) present during fabrication. One example is in the production of PPE gloves, such as latex gloves, vinyl gloves, or nitrile rubber glove. During fabrication of gloves, a dry form of a disinfectant composition may be incorporated into a liquid monomer, a liquid-phase prepolymer, or a polymer melt, for example.

In certain embodiments, the polymer component of the disinfectant composition is the same polymer as that contained in an object. For example, PPE gloves may be made with poly(vinyl alcohol) which may be the selected polymer component of the disinfectant composition. In these embodiments, preferably the silver-containing compound is incorporated into the object during its fabrication, so that the complexing with the polymer may occur to inhibit silver oxidation.

In some embodiments, cold spraying is utilized to introduce a dry form of a disinfectant composition, without a solvent necessarily being present at all. Cold spraying is a deposition method in which powders are accelerated in a supersonic gas jet to high velocities and then impacted with a substrate, wherein the powder particles undergo plastic deformation and adhere to the surface. If incorporated into the overall fabrication process, cold spraying may be used to impregnate a dry disinfectant composition into the bulk phase of an object, such as PPE equipment, fabrics, textiles, and the like. It is also possible, in some cases, to use cold spraying to impregnate the disinfectant composition into the bulk phase of an object after it has been fabricated, if the object has sufficient porosity or if the powder particles impact the object with enough energy to penetrate to the bulk region.

Certain embodiments of the invention provide an antimicrobial textile impregnated with a disinfectant composition disclosed herein. In addition to techniques described above, standard textile processing may be adapted to introduce the disinfectant composition to the textile. For example, padding, exhaust, and other textile processing steps (including those used for dyeing) may be adapted for incorporating the disinfectant composition into the textile bulk phase, onto its surface, or into a fixed depth but not entirely within the bulk phase. Preferably, the disinfectant composition is incorporated in a manner such that it remains within the textile even after multiple washes.

### EXAMPLES

### Example 1: Preparation of a Disinfectant Composition

This example describes the preparation of 1 liter of a disinfectant composition. About 700 mL deionized water is combined in a flask with 200 g trisodium citrate, and the combined mixture is thoroughly agitated. Then, 2 g AgNO₃ (silver nitrate) is carefully added to the mixture and mixed well, to obtain a second mixture. The order of addition prevents the oxidation of the silver ions and allows the silver to remain in the metallic, complexed form (i.e., as molecular AgNO₃ rather than as Ag⁺ and NO₃⁻ ions). Then, 20 g poly(vinyl pyrrolidone) is added to the second mixture, and deionized water is added to reach a total volume of 1 liter.

The composition is then filtered through a 10-micron filter. Additional components, such as Triton X-100 (polyoxyethylene octyl phenyl ether) and melamine may then be added to the composition. The concentration of silver nitrate is about 0.2 wt %.

### Example 2: Disinfectant Composition

A general disinfectant composition is prepared by mixing the starting components together, in a manner substantially as described in Example 1. The final disinfectant composition is as follows:

Silver nitrate, 2 wt %

Poly(vinyl pyrrolidone), 4 wt %

Ethylenediaminetetraacetic acid (EDTA), 1 wt %

Silica powder, 0.5 wt %

Water, remainder

### Example 3: Disinfectant Composition for Fabric

A disinfectant composition for a fabric is prepared by mixing the starting components together, in a manner substantially as described in Example 1. The final disinfectant composition is as follows:

Silver nitrate, 2 wt %

Poly(vinyl pyrrolidone), 4 wt %

Ethylenediaminetetraacetic acid (EDTA), 1 wt %

Silica powder, 0.5 wt %

Titania powder, 1 wt %

Water, remainder

### Example 4: Disinfectant Composition

A general disinfectant composition is prepared by mixing the starting components together, in a manner substantially as described in Example 1. The final disinfectant composition is as follows:

Silver nitrate, 2 wt %

Poly(vinyl pyrrolidone), 4 wt %

Trisodium citrate, 10 wt %

Triton X-100 (polyoxyethylene octyl phenyl ether), 0.1 wt %

Melamine, 1 wt %

Water, remainder

### Example 5: Dry Disinfectant Composition for Gloves.

A disinfectant composition for PPE gloves is prepared by mixing the starting components together, in a manner substantially as described in Example 1. The final disinfectant composition is as follows (note that no solvent is present):

Silver nitrate, 0.66 wt %

Poly(vinyl pyrrolidone), 55 wt %

Trisodium citrate, 33 wt %

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims. Furthermore, various aspects of the invention may be used in other applications than those for which they were specifically described herein.

What is claimed is:

1. A disinfectant composition comprising:
(a) a silver-containing compound;
(b) a polymer;
(c) a reducing agent; and
(d) optionally, a wetting agent.

2. The disinfectant composition of claim 1, wherein said silver-containing compound is a silver salt.

3. The disinfectant composition of claim 2, wherein said silver salt is silver nitrate.

4. The disinfectant composition of claim 1, wherein said silver-containing compound is present in a concentration from about 0.01 wt % to about 5 wt %.

5. The disinfectant composition of claim 1, wherein said polymer is a hydrophilic polymer.

6. The disinfectant composition of claim 1, wherein said polymer is selected from the group consisting of polyacrylamide, poly(acrylamide-co-acrylic acid), poly(vinyl alcohol), poly(vinyl pyrrolidone), poly(ethylene oxide), carboxy methyl cellulose, and combinations thereof.

7. The disinfectant composition of claim 1, wherein said polymer is present in a concentration from about 1 wt % to about 5 wt %.

8. The disinfectant composition of claim 1, wherein said reducing agent is selected from the group consisting of citric acid, citrate salt, ascorbic acid, ascorbate salt, ethylenediaminetetraacetic acid, ethylenediaminetetraacetate salt, and combinations thereof.

9. The disinfectant composition of claim 1, wherein said reducing agent is present in a concentration from about 1 wt % to about 50 wt %.

10. The disinfectant composition of claim 1, wherein said wetting agent is present and is at a concentration from about 0.1 wt % to about 5 wt %.

11. The disinfectant composition of claim 10, wherein said wetting agent is selected from the group consisting of polyethoxylated castor oil; polypropylene glycol-polyethylene glycol block copolymers; polyoxyethylene sorbitan monooleate; sodium lauryl sulfate; sodium carboxymethyl cellulose; calcium carboxymethyl cellulose; hydrogenated or non-hydrogenated glycerolipids; ethoxylated or non-ethoxylated, linear or branched, saturated or monounsaturated or polyunsaturated C₆ to C₃₀ fatty acids or salts thereof; cyclodextrin; alkaline earth metal or amine salt ethoxylated or non-ethoxylated esters of sucrose; sorbitol; mannitol; glycerol or polyglycerol containing from 2 to 20 glycerol units; glycols combined with fatty acids, monoglycerides, diglycerides, triglycerides, or mixtures of glycerides of fatty acids; ethoxylated or non-ethoxylated, linear or branched, saturated or monounsaturated or polyunsaturated C₆ to C₃₀ fatty alcohols; sterols; cholesterol or derivatives thereof; ethoxylated or non-ethoxylated ethers of sucrose, sorbitol, mannitol, glycerol, or polyglycerol containing from 2 to 20 glycerol units; hydrogenated or non-hydrogenated, polyethoxylated vegetable oils; polyethylene glycol hydroxystearate; sphingolipids or sphingosine derivatives; polyalkyl glucosides; ceramides; polyethylene glycol-alkyl glycol copolymers; polyethylene glycol-polyalkylene glycol ether di-block or tri-block copolymers; diacetylated monoglycerides; diethylene glycol monostearate; ethylene glycol monostearate; glyceryl monooleate; glyceryl monostearate; propylene glycol monostearate; polyethylene glycol stearate; polyethylene glycol ethers; polyethylene glycol hexadecyl ether; polyethylene glycol monododecyl ether; polyethylene glycol nonyl phenyl ethers; polyethylene glycol octyl phenyl ethers; octylphenoxy polyethoxyethanol; polyhydroxyethyl-tert-octylphenolformaldehyde; poloxamers; polysorbates; sorbitan monolaurate; sorbitan monooleate; sorbitan monopalmitate, sorbitan monostearate; sorbitan sesquioleate; sorbitan trioleate; sorbitan tristearate; phospholipids; and combinations thereof.

12. The disinfectant composition of claim 1, wherein said disinfectant composition further comprises a binding agent.

13. The disinfectant composition of claim 12, wherein said binding agent is selected from the group consisting of melamine, thiols, fatty acids, and combinations thereof.

14. The disinfectant composition of claim 12, wherein said binding agent is present in a concentration from about 1 wt % to about 5 wt %.

15. The disinfectant composition of claim 1, wherein said silver-containing compound is coated with a layer comprising phospholipids bonded with hydrophobic thiols and/or unsaturated fatty acids.

16. The disinfectant composition of claim 1, wherein said disinfectant composition further comprises a copper-containing compound that is present in a concentration from about 0.01 wt % to about 5 wt %.

17. The disinfectant composition of claim 1, wherein said disinfectant composition is in solution, gel, or spray form.

18. The disinfectant composition of claim 1, wherein said disinfectant composition is present in a hand-sanitizer formulation.

19. The disinfectant composition of claim 1, wherein said disinfectant composition is present in a coating on a substrate surface.

20. The disinfectant composition of claim 1, wherein said disinfectant composition is present as a bulk component within a material or object.

21. A disinfectant composition comprising:
(a) silver nitrate;
(b) a polymer;
(c) a reducing agent;
(d) optionally, a wetting agent;
(e) optionally, a binding agent; and
(f) water.

22. The disinfectant composition of claim 21, wherein said silver nitrate is present in a concentration from about 0.01 wt % to about 5 wt %.

23. The disinfectant composition of claim 21, wherein said polymer is poly(vinyl pyrrolidone).

24. The disinfectant composition of claim 21, wherein said reducing agent is selected from the group consisting of citric acid, a salt of citric acid, ethylenediaminetetraacetic acid, a salt of ethylenediaminetetraacetic acid, and combinations thereof.

25. The disinfectant composition of claim 21, wherein said wetting agent is polyoxyethylene octyl phenyl ether.

26. The disinfectant composition of claim 21, wherein said binding agent is melamine.

27. The disinfectant composition of claim 21, wherein said disinfectant composition further comprises silicon dioxide and/or titanium dioxide.

28. The disinfectant composition of claim 21, wherein said disinfectant composition is present in a coating on a substrate surface.

29. The disinfectant composition of claim 21, wherein said disinfectant composition is present as a bulk component within a material or object.

30. The disinfectant composition of claim 29, wherein said material or object is a glove.
